(19) United States
(12) Patent Application Publication
(10) Pub. No.: US 2017/0192651 A1
(43) Pub. Date: Jul. 6, 2017

(54) EDITING PHOTOS OVER AN ONLINE SOCIAL NETWORK

(71) Applicant: Facebook, Inc., Menlo Park, CA (US)

(72) Inventors: Daniel Shannon Yang, Menlo Park, CA (US); Mircea-Gabriel Suciu, London (GB); Mihaela Ogrezeanu, London (GB); Balazs Balazs, London (GB)

(21) Appl. No.: 14/984,424

(22) Filed: Dec. 30, 2015

(51) Int. Cl. G06F 3/0484; G06F 3/0481; H04L 29/08; H04L 29/06; H04L 12/58; G06T 11/60; G06T 1/00

(52) U.S. Cl. CPC G06F 3/04845; G06T 11/60; G06F 3/04817; G06T 1/0007; H04L 67/42; H04L 51/32; H04L 67/02; H04L 67/306; G06T 2200/24

(57) ABSTRACT

In one embodiment, a method includes a computer server machine that may receive from a first user instructions to edit an original photo. The original photo may have been uploaded by a second user. The first and second users may be users of an online social network. The computer server machine may create an edited photo based on the original photo in accordance with the instructions. The computer server machine may also store the edited photo in association with the first user. The computer server machine may also distribute the edited photo in association with the original photo.

### TECHNICAL FIELD

This disclosure generally relates to editing and posting photos on the Internet.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

In particular embodiments a method wherein a computer server machine may receive a photo and instructions to edit the photo from a user. The computer server machine may store an edited version of the photo in association with the user, wherein the edited version has been updated in accordance with the instructions. The computer server machine may also distribute the edited version of the photo.

In particular embodiments, a user may upload a photo to an online social network. Such a user may be referred to as an “original poster.” The uploaded photo may be viewable by the original poster's friends, friends of friends, or the general public. In some embodiments, access for viewing may depend upon the original poster's privacy settings. These users may view the photo or make edits to the original photo using a unified photo editing tool. This tool may also be referred to as a “Unified Editing Modal.” The term “modal” may be understood in the context of modal window, which is a graphical element subordinate to an application's main window and prevents the main window from being used. In some embodiments, access for editing may depend upon the original poster's privacy settings. The unified photo editing tool may enable users to edit an original photo and upload it onto the Internet. In particular embodiments, a user may be able to upload a photo onto an online social network. In particular embodiments, a user may be able to write a comment about an original photo, where the comment incorporates an edited version of the original photo. This may be accomplished by clicking or tapping on the original photo or on an icon indicating the user wishes to comment on the original photo where the comment incorporates an edited version of the original photo. using. A right-click, double tap, or any type of gesture may also suffice, as well as dragging the original photo into an editing region. The edits may include adding stickers/icons/emoji or text to the photo, drawing on the photo, animating the photo or elements within the photo, adding audio or sound effects to the photo, or using image-editing software to edit the photo. The image-editing software may include tools for cropping the photo, modifying aspects of the photo (e.g., increasing or decreasing saturation, contrast, shadows, highlights, hues), resizing, skewing, or blurring the photo or portions thereof, merging two or more photos, and the like. The image editing software may also include filters to lay over the photo. The image editing software may also be capable of storing a user's edits for use on future photos. Once a second user has made edits to the original photo, the second user may post the edited photo to the social network. In particular embodiments the edited photo may be posted in the comments section of the original photo. It is also contemplated that the original poster may make edits to an original photo and post an edited version of the original photo as well. In particular embodiments, a user may make additional edits to a photo that may have been previously edited and posted.

In particular embodiments, once an edited version of an original photo has been posted, the user who posted the original photo may have the ability to delete, hide, or restrict viewing access to the edited photo. Alternatively, the creator of the edited photo may retain possession or control of the edited photo even after the edited photo or the original photo is deleted. Thus, the creator of the edited photo may not lose the edited photo when either the original photo or the edited photo are deleted. These and other embodiments of the invention will be discussed further below.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example method for editing a photo using the unified photo editing tool.

FIG. 2 illustrates a first example screenshot of an interface of a unified photo editing tool.

FIG. 3 illustrates a second example screenshot of an interface of a unified photo editing tool.

FIG. 4 illustrates an example network environment associated with a social-networking system.

FIG. 5 illustrates an example social graph.

FIG. 6 illustrates an example computer system.

### DESCRIPTION OF EXAMPLE EMBODIMENTS

The invention described herein may enable a user to make edits to an original photo that has been posted on an online social networking system. The invention described herein accomplishes may enable a user to make edits to an original photo that has been posted on an online social networking system by executing the following steps: first, a computer server machine may receive a photo and instruction to edit the photo. The photo and instructions to edit the photo may come from a user of the online social networking system. Second, either the client device or the computer server machine may check to determine whether the computer server machine has permission to execute the editing instructions. Alternatively, the client device or computer server machine may check to determine whether edits are allowed to be made to the photo before any instructions to edit are made or sent. Third, if the user grants permission to edit, the instructions to edit may be executed according to one of the processes discussed below. Instructions to edit a photo may include may include adding stickers/icons/emoji or text to the photo, drawing on the photo, animating the photo or elements within the photo, adding audio or sound effects to the photo, or using image-editing software to edit the photo. The image-editing software may include tools for cropping the photo, modifying aspects of the photo (e.g., increasing or decreasing saturation, contrast, shadows, highlights, hues), resizing, skewing, or blurring the photo or portions thereof, merging two or more photos, and the like. The image editing software may also include filters to lay over the photo. Additionally, several privacy and ownership possibilities are contemplated by this invention, which are discussed in detail below.

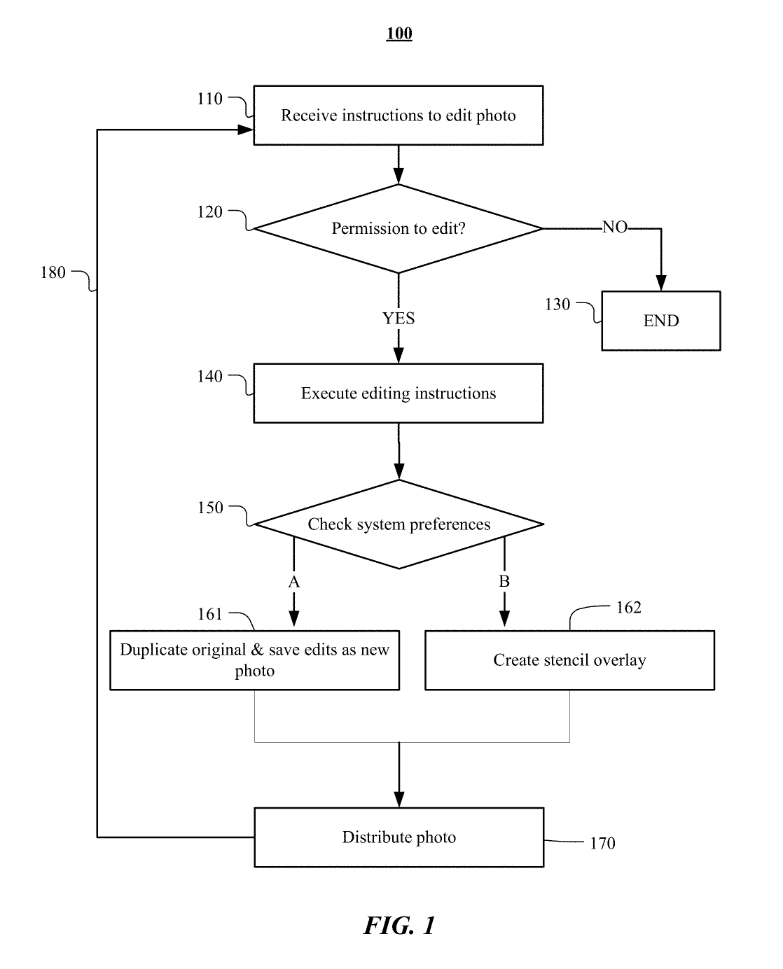

FIG. 1 illustrates an example method 100 for editing a photo according to the invention described herein. The method may begin at step 110, where a computer server machine may receive a photo with instructions to edit the photo. The photo originally received by the computer server machine will hereinafter be referred to as the original photo. This original photo may be any photo of a person, group of people, an object, animals, landscapes, or anything. It may be a photo that a user took him or herself, or it may be a photo taken by a different person. The instructions to edit the photo will be explained in more detail below.

At step 120, the computer server machine may check to ensure that it has permission to edit the photo. In some embodiments, the user who uploaded the original photo may have enacted privacy settings which prevent the photo from being edited by third parties. In other embodiments, the user may have no privacy settings enabled. Additionally or alternatively, the photo may contain copyright protections in its metadata (protected from distribution under, for example, the Digital Millennium Copyright Act), which may also prevent the photo from being edited. In some embodiments, permission may be granted to execute only certain kinds of edits for a particular photo. This permission may result from the original poster's privacy settings or other settings. For example, and not by way of limitation, a user may upload an original photo, and specify that only certain edits are allowed, and other edits are not. For example, the user may upload a selfie and specify that edits to make the user look overweight (i.e., edits similar to those made by the “FAT BOOTH” and/or “FAT MAKER” applications) are not allowed.

In other embodiments, permission to edit may depend on the relationship between the original poster and the user wishing to edit the photo. In other embodiments, permission to edit may depend on which group or groups the original poster belongs to, posted the photo in, or the user requesting to edit belongs in. For example, and not by way of limitation, a user may post a photo in a group environment (i.e., to a specific group so that only members of that group may view the photo), and specify that only members of that group may edit the photo. As another example, a user may post a photo publicly, but specify that only members of a specific group or groups may edit the photo.

If permission is granted, the computer server machine may move to step 140, where it may execute the editing instructions. If permission is denied, the computer server machine may prevent the user from making edits to the original photo using the unified photo editing tool. In this case, the method may end at step 130. In some embodiments, based on the privacy settings, the user may not be presented with a user interface that enables the user to edit the photo (e.g., the button the “Edit Photo” may not be displayed, or, rather than opening an editing interface when clicked, the user interface may simply zoom in on the original photo).

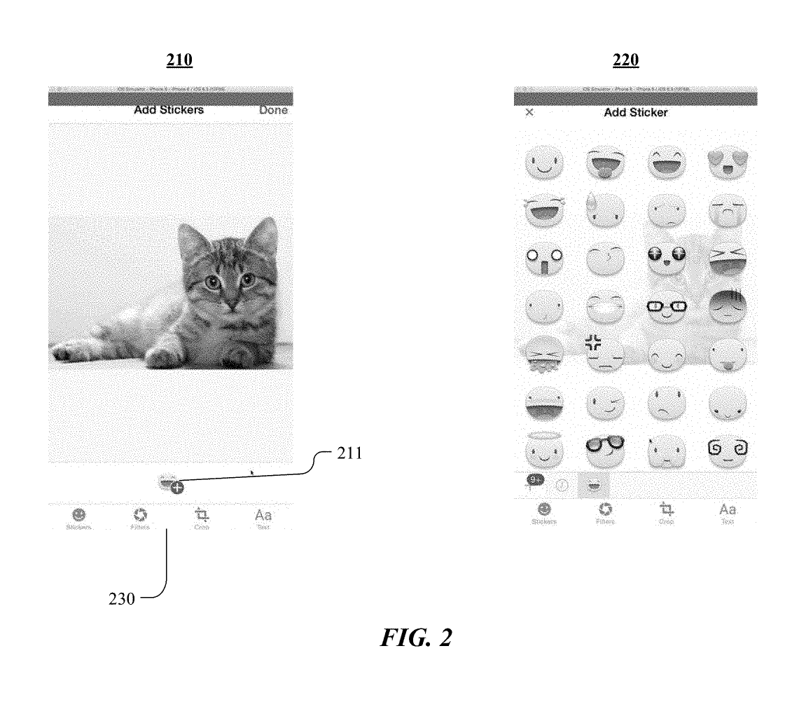

Instructions to edit a photo may include instructions to place “stickers” on the photo. These stickers may be any image. For example, a sticker may be a cartoon drawing of a smiley face, like that shown in FIG. 2. Alternatively, a sticker may be an actual photograph of a person's face, for example, Nicolas Cage, or an icon, emoji, or clipart image. Thus, a user may be able to place a sticker of Nicolas Cage's face over one or more faces in the original photo. The stickers may also be adjustable in size and orientation by selecting the sticker handle icon 312. A user may select and move the sticker handle icon 312 to adjust the size and orientation of the sticker.

In particular embodiments, a user may edit a photo by applying one or more filters to a photo. Such filters may alter the color tone of the photo, may provide a vintage feel to the photo, or may enhance the photo in various other ways. To apply a filter, a user may select the filter icon from the control buttons 230 as shown in FIG. 2. Then the user may select a filter and may view a preview of the photo with the filter applied. If a user a wishes to apply a particular filter, the user may indicate it, and the appropriate filter may be applied. Additionally, a user may use several filters and save the combination of filters used for future edits of photos.

In particular embodiments, a user may edit a photo by applying text to a photo. Such text may appear anywhere on the photo. The language of the text may be input by a user. To apply text to a photo, a user may select a text icon from the control buttons 230 as shown in FIG. 2. Once the user selects the text icon, a text box may appear on the photo. The text box may be moveable, for example, by dragging the box to various locations on the photo using either a computer cursor or dragging a finger across a touch screen display. The text may be displayed in various fonts, colors, and sizes, all selectable inside the unified photo editing tool.

In particular embodiments, a photo may be cropped and/or resized. Such cropping and/or resizing may be applied to any area of a photo. To crop and/or resize a photo, a user may select a crop icon from the control buttons 230 as shown in FIG. 2. Once the user selects the crop icon, a crop box may appear over the photo. The user may adjust the size and location of the crop box by clicking and dragging the crop box or by dragging a finger along a touch screen display. Once the user has configured the crop box to a desirable size and/or location, the cropping may be applied to the photo.

The edits that may be made to a photo are not limited to the control buttons 230 in FIG. 2. Other edits and enhancements may be made. In particular embodiments, sounds may be applied to a photo. Sounds may either be pre-packaged or recorded at the time of their application to the photo. To apply a sound or audio feature, a user may select a sound icon and either select a pre-packaged sound or may choose to record a sound. An example of a pre-packaged sound may include a sound of a cow mooing. The user may select an icon labeled “cow moo” and may apply it to a photo. Then, after the photo is posted the cow moo sound may be activated either automatically, or when a user selects (e.g., by tapping, clicking, hovering a cursor over part of the photo, etc.) a particular location on the photo. For example, if a photo depicts a group of friends, a user may apply a “cow moo” sound to one of the people depicted in the photo. Thus, the cow moo sound may be activated and played when a user selects (e.g., by tapping, clicking, hovering a cursor over part of the photo, etc.) that friend's face or body.

Alternatively, a user may record a sound and add it to a photo. For example, a user may select a sound icon and further select an icon indicating that the user wishes to record a sound. Then the user may speak or otherwise record a sound. It is contemplated that advertisers may record brief advertisements to place on photos in this manner.

In particular embodiments, a user may have the option to apply a different background to the photo. Such a background may be a landscape of a famous geographic location, such as the surface of the moon, or the Grand Canyon. To apply a background, the user may select the background icon and then may select the desired background. The computing device may then detect the photo's foreground and background, and replace the photo's background with the new background selected by the user. For example, an original photo may depict a group of friends outside a local MCDONALD'S restaurant. A user may wish to replace the MCDONALD'S background with a background of the Swiss Alps. The user may select the Swiss Alps background and apply it to the original photo. To detect the foreground and background of an original photo, the computing device may either use a foreground and/or background detection algorithm, or it may request that the user identify what is foreground and what is background. To do this, the computing device may request that the user trace around the foreground images to identify them. Alternatively, the user may simply click or tap on the foreground images and the computing device may use this information to detect the foreground and background. Once the background has been detected, the original background image of the MCDONALDS restaurant may be replaced with the selected background image of the Swiss Alps.

In particular embodiments, interactive elements may be added to the photo. Such elements may include features that appear when a user selects (e.g., by tapping, clicking, hovering a cursor, etc.) a pre-determined location on the photo. For example, a fashion blogger may post a picture of her latest fall outfits. She may upload a photo depicting herself with a sweater from J. CREW for $98, denim jeans by CURRENT ELLIOTT for $228, high heels by CHRISTIAN LOUBOUTIN for $825, and a tote by Tory Burch for $295. Instead of adding a description of all these clothing items beneath the picture, the fashion blogger may add these features as interactive text and/or stickers, within the unified photo editing tool. Thus, as a result of adding these features, when a user selects (e.g., by tapping, clicking, hovering a cursor over part of the photo, etc.), for example, the denim jeans, a text box may appear informing the user that the jeans are made by CURRENT ELLIOTT and they cost $228. The text box may also provide a link to a website where the jeans are available to purchase.

In particular embodiments, the interactive elements could include interactive elements from third parties. To continue the above example, the fashion blogger may allow other third parties to comment on her original photo, wherein the comment incorporates an edited version of the original photo. For example, OLD NAVY may offer a pair of denim jeans that look similar to the pictured CURRENT ELLIOTT jeans, but cost $28 instead of $228. OLD NAVY may add an interactive element to the original photo, advertising for OLD NAVY jeans. Thus, when a user selects (e.g., by tapping, clicking, hovering a cursor over part of the photo, etc.) or otherwise activates an area of the photo over the pictured denim jeans, the OLD NAVY jeans may appear as a photo overlay, so that a user may compare the OLD NAVY jeans to the CURRENT ELLIOTT jeans without ever clicking through to another screen.

It is contemplated that the above described third-party interactive feature additions may apply to a wide variety of applications. For example, a hair salon may add an interactive feature advertising a particular hair product or promotional message to appear when a user selects (e.g., by tapping, clicking, hovering a cursor over part of the photo, etc.) an area of a picture depicting a woman's hair. Another example may include a restaurant adding an interactive feature advertising a particular dish to appear over a photo of a plate of food. Travel companies may also desire to add interactive elements to photos. For example, when a user is viewing his or her friend's photos of a recent trip to the Caribbean, an airline company may wish to place an interactive element advertising airfare to the Bahamas.

The editing of the photo may occur in one or more locations. It is contemplated that the photo is edited completely within the unified photo editing tool, so that a user is not required to download the original photo, edit it with third party software, and then upload the edited photo. However, integration with third party software may be desirable in some cases. For example, if a user desires to make extensive edits to an original photo, it may be desirable to use third-party software that may have more powerful editing capabilities. In this case, the invention described herein may integrate with third-party photo editing software to accomplish the desired photo edits.

In step 150, the computer server machine may check the system preferences which may be located on one or more of the client device, the user profile, or the server, to determine how to execute the editing instructions. There may exist at least two ways to execute the photo. The first way may be to duplicate the original photo, as shown in step 161, and the second way may be to create a stencil overlay to go on top of the original photo, as shown in step 162. If the system preferences indicate a preference to duplicate the original photo, the method proceeds to step 161. To execute step 161, the unified photo editing tool may first make a copy of the original photo, then apply the editing instructions to that copy. Alternatively the computer server machine may make a copy of the original photo and then apply the editing instructions to that copy. This may result in the creation of an additional photo each time a user edits the original photo. It may also result in the creation of an additional photo each time a user edits a posted edited photo.

If the system preferences indicate a preference to create a stencil overlay, as shown in step 162, the user may edit the original photo (e.g., place stickers, text, interactive elements, change saturation, contrast, etc.), but instead of creating a duplicate photo with the edits executed, the unified photo editing tool may create a “stencil” of the edits. In other words, the edits may be executed and saved onto a template, and a pointer to the original photo may be created, so that a user may see the original photo with the edits superimposed onto the original photo. In this case, if the poster of the original photo deletes the original photo, the underlying photo in the edited photo may be deleted, but the edits may be retained. Thus, if this option is implemented, the original poster may retain ownership and control over her original photo, and each editor may retain ownership and control over his or her edits. It is also contemplated that checking the system preferences may be completed before executing the editing instructions. In this case, the checking of the system preferences may be performed in response to a request from a user to edit a posted photo.

There may exist a number of reasons to check the system preferences in step 150 to determine how to execute the editing instructions. For example, if a user who uploads an original photo does not wish for other users to easily make copies of the original photo, the user may set a preference that the original photo may not be duplicated. Thus, the method may proceed to step 162 instead of 161. Another reason may be that it may be more efficient to simply create a stencil of the edits instead of duplicating the original photo.

After the photo has been edited using one of the above processes, the method may proceed to step 170. In step 170, the edited version of the photo may be distributed. The edited photo may be distributed in a comments section associated with the original photo. It may also be distributed to other locations, such as personal message inboxes, profile pages, and the like. A distributed edited photo may be viewable by the original poster's friends, friends of friends, or the general public. In some embodiments, viewing access may depend on the original poster's privacy settings. Alternatively, the eligible viewers of the distributed edited photo may be determined by the privacy settings of the user who edited and distributed the edited photo. Thus, the photo may be viewable by the editor's friends, friends of friends, or the general public. It is contemplated that the original poster may retain ownership and ultimate control of the original photo and all edited photos uploaded in conjunction with the original photo. Thus, the original poster may delete the original photo and may delete all edited versions of the original photo. It is also contemplated that the users who made edits to the original photo may retain control and ownership of their edited versions of the original photo. This may be accomplished by duplicating the original photo and allowing a user to save that photo in a photo album or other means of photo storage. Alternatively, the users who made edits to the original photo may retain ownership and control of the edits they have made to the original photo. This may be accomplished by saving the edits a user has made. A user may make an edit template and may thus apply the same edits to multiple photos.

Once the edited version of the photo has been distributed, it may itself become available to be edited. That is, a user may edit an edited version of an original photo. Thus, in step 180, the method may start over when a user inputs instructions to edit the edited version of a photo. Edits of edited photos may occur in at least three ways. First, the edited photo may be duplicated, edited, and saved as a new photo. This may result in the creation of at least three separate photos: the original photo, the first edited photo, and the second edited photo. Thus, with this method, each time a photo is edited, a new photo may be created. Second, a pointer may be created which points to the original photo, and either the unified photo editing tool or the computer server machine may execute the edits of both the first edit and the second edit. This may result in the creation of a single photo (i.e., the original photo), with multiple instructions to lie edits over the original photo. Third, the unified photo editing tool and/or the computer server machine may perform a combination of the first two methods described above. For example, the unified photo editing tool and/or the computer server machine may point to the edited photo (which may be the result of duplicating the original photo and then executing a first set of editing instructions) and execute the second set of editing instructions. In this case, two photos may be created: the original photo, and the edited photo (with the first set of editing instructions). The second set of editing instructions may be executed not on a duplicate of the edited photo, but rather as a pointer to the edited photo.

In particular embodiments, when an original photo is edited using one of the methods described above, or when an edited photo is edited using one of the methods described above, it is contemplated that the edited photo may be “reshared.” Resharing an edited photo may be understood to mean that a user other than the poster of the original photo uploads the edited photo in a region on the online social network that is independent of the region where the original photo was uploaded. As an example and not by way of limitation, User A may share a photo of a cat on the online social network. User B may see User A's photo of the cat in User B's newsfeed. According particular embodiments of the invention described herein, User B may edit User A's cat photo using the unified photo editing tool, by placing a sticker of a piece of bread around the cat's head. User B may complete the editing of User A's cat photo by selecting “done” or otherwise indicating that User B has completed editing the photo. This may create an edited version (i.e., edited photo) of the original photo User A uploaded. User B may then be presented with an option to comment using the photo, or to reshare the photo. If User B selects to comment using the photo, User B's edited photo (with the breading sticker added) may appear in the comments region of the original photo or story. If User B selects “reshare,” the edited photo may appear prefilled in a new “compose flow” (i.e., a new flow that may allow a user to share a photo as her own photo in a region independent of the original photo, for example, as a post, as a message, etc.). Thus, selecting reshare may allow User B to share an edited version of User A's photo as a new post, instead of sharing it in the comments section to User A's original photo. It is contemplated that User B may reshare an edited version of User A's photo unless User A has turned off resharing or has otherwise restricted a photo from being reshared. Alternatively, resharing may be defaulted to off, and User B may only be allowed to reshare an edited version of User A's photo if User A has turned on resharing. Either way, the ability to reshare photos may be under the discretion of the user who posts the photo.

In some embodiments, a user may create a custom sticker. The custom sticker may be created by any means available to the user (e.g., hand drawn and scanned, PHOTOSHOP, a painting application, etc.). The custom sticker may be uploaded onto the social network and/or unified photo editing tool for the user to reuse on subsequent photos. Further, the custom sticker may be made available for other users to use as well. As an example, and not by way of limitation, a user may create a sticker that may be called “breading.” This breading sticker may be a picture of a slice of bread with a hole cut through the middle. The breading sticker may further be positioned anywhere on a photo, preferably so that the hole cut through the middle of the slice of bread is positioned over a person's head, to mimic the “cat breading” pictures that are currently being distributed on the Internet. A user may create a breading sticker and make it available for other users to place on future photos. It is contemplated that a user who uploads a custom sticker may sell his sticker for money or otherwise exchange his sticker for something of value.

In particular embodiments, a user may create a series of edits on a single photo (e.g., applying filters, stickers, and/or other editing features). The user may save the series of edits to create what will be referred to as a reusable template of edits. In some embodiments, the template of edits may be reused by the user on subsequent photos, or may be reused by other users on subsequent photos. As an example, and not by way of limitation, a user may create a Halloween template, wherein edits may comprise some or all of the following features: the brightness and contrast of the photo have been lowered; the color saturation has been lowered; and an outer glow feature has been added to features in the foreground of the original photo. The user may save these edits as a Halloween template. The unified photo editing tool and/or social network may make this Halloween template available for other users so that anyone who wants to make an original photo spooky for Halloween may do so. It is contemplated that a user who uploads a template of edits may sell his template of edits for money or otherwise exchange his template of edits for something of value.

Particular embodiments may repeat one or more steps of the method of FIG. 1, where appropriate. Although this disclosure describes and illustrates particular steps of the method of FIG. 1 as occurring in a particular order, this disclosure contemplates any suitable steps of the method of FIG. 1 occurring in any suitable order. Moreover, although this disclosure describes and illustrates an example method for editing a photo using the unified photo editing tool including the particular steps of the method of FIG. 1, this disclosure contemplates any suitable method for editing a photo using the unified photo editing tool including any suitable steps, which may include all, some, or none of the steps of the method of FIG. 1, where appropriate. Furthermore, although this disclosure describes and illustrates particular components, devices, or systems carrying out particular steps of the method of FIG. 1, this disclosure contemplates any suitable combination of any suitable components, devices, or systems carrying out any suitable steps of the method of FIG. 1.

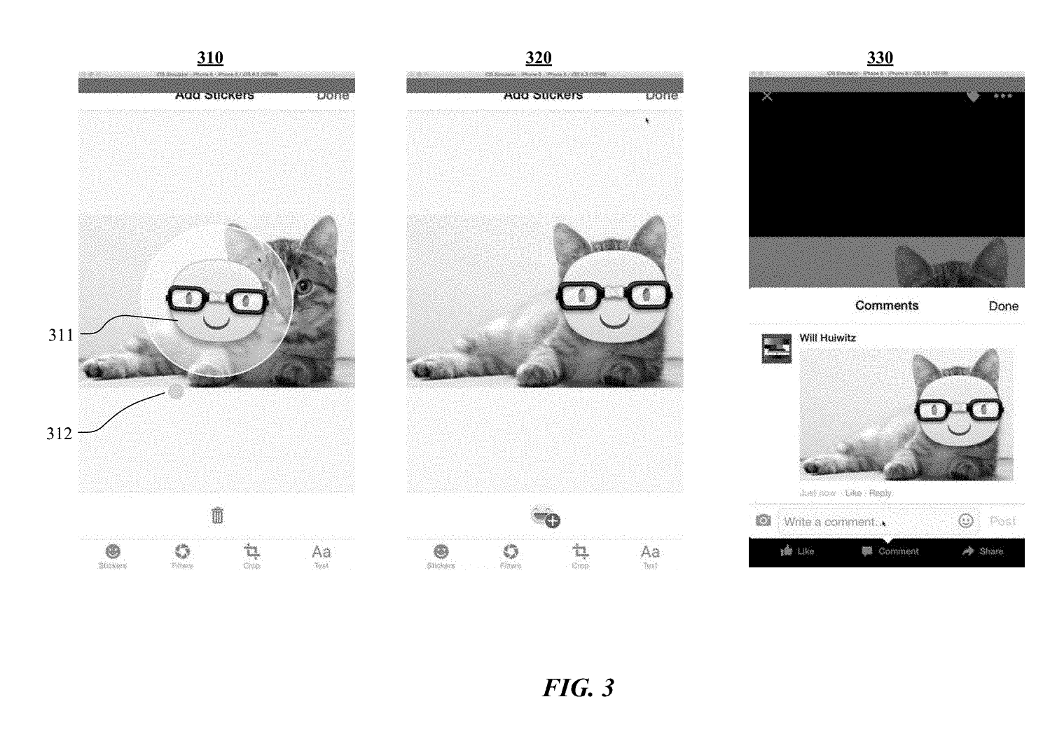

FIGS. 2 and 3 are examples of what a user may see when he or she comments using the photo. A user may see a photo on the Internet. More specifically, a user may see a photo that she has uploaded herself, or she may see a friends' photo, a friend-of-a-friend's photo, or a stranger's photo on the Internet. According to the invention described herein, the user may have the option to comment on the original photo. The comment may incorporate an edited version of the original photo. There may be an icon that the user may select to invoke the unified photo editing tool discussed above. When this icon is selected, the user's screen may display a first screen 210 the photo along with control buttons 211 and 230. Sticker control button 211 may activate a second screen 220 that may allow a user to select one or more stickers to place on the photo. A user may select a sticker by clicking or otherwise selecting the sticker, and either dragging, copying and pasting, or otherwise moving a particular sticker onto the photo.

Instead of sticker control button 211, a user may select one of the other control buttons 230, which may include, but are not limited to, filters, cropping tools, text, and other image editing software. The other image editing software may include tools to adjust saturation, contrast, shadows, highlights, and the like. These features are described in detail above The image editing software may also include tools to stretch or skew the photo. To accomplish any of the above edits, a duplicate photo may be created, or a pointer and stencil overlay may be created, as discussed above. An additional way to accomplish the edits may include storing the instructions (either on the client device or on the computer server machine) and creating a temporary duplicate photo with one or more sets of editing instructions executed on the temporary duplicate. This may be necessary when stretching or skewing the original photo, because a stencil overlay may be unavailable for a stretch or skew edit.

If a user selects a sticker 311 to place on top of a photo, the sticker 311 may appear on top of the photo, as shown in frame 310 of FIG. 3. The user may change the size or orientation of the sticker 311 by moving the sticker handle icon 312. The user may place one or more stickers anywhere on the photo, as shown in frame 320. Finally, the user may insert the photo as a comment in a comment region associated with the original photo, as shown in frame 330. It is contemplated that many edited versions of the original photo may be placed in a comment region associated with the original photo. Thus, many users may create their own renditions of an original photo, and comment on the original photo, wherein the comment may incorporate their edited photo. Further, all the above actions may be done within the unified photo editing tool.

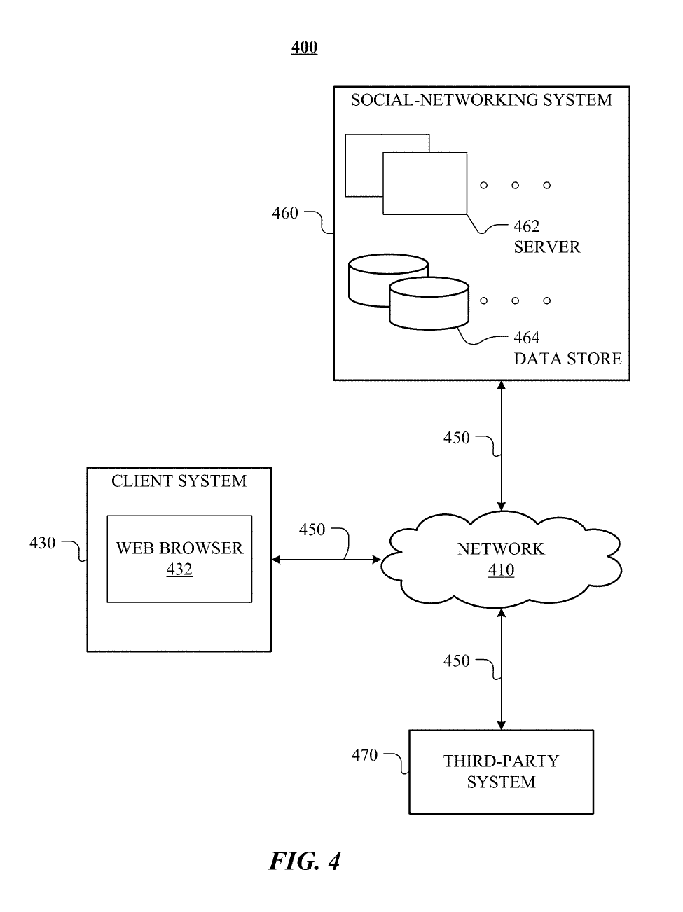

FIG. 4 illustrates an example network environment 400 associated with a social-networking system. Network environment 400 includes a client system 430, a social-networking system 460, and a third-party system 470 connected to each other by a network 410. Although FIG. 4 illustrates a particular arrangement of client system 430, social-networking system 460, third-party system 470, and network 410, this disclosure contemplates any suitable arrangement of client system 430, social-networking system 460, third-party system 470, and network 410. As an example and not by way of limitation, two or more of client system 430, social-networking system 460, and third-party system 470 may be connected to each other directly, bypassing network 410. As another example, two or more of client system 430, social-networking system 460, and third-party system 470 may be physically or logically co-located with each other in whole or in part. Moreover, although FIG. 4 illustrates a particular number of client systems 430, social-networking systems 460, third-party systems 470, and networks 410, this disclosure contemplates any suitable number of client systems 430, social-networking systems 460, third-party systems 470, and networks 410. As an example and not by way of limitation, network environment 400 may include multiple client system 430, social-networking systems 460, third-party systems 470, and networks 410.

This disclosure contemplates any suitable network 410. As an example and not by way of limitation, one or more portions of network 410 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 410 may include one or more networks 410.

Links 450 may connect client system 430, social-networking system 460, and third-party system 470 to communication network 410 or to each other. This disclosure contemplates any suitable links 450. In particular embodiments, one or more links 450 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 450 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 450, or a combination of two or more such links 450. Links 450 need not necessarily be the same throughout network environment 400. One or more first links 450 may differ in one or more respects from one or more second links 450.

In particular embodiments, client system 430 may be an electronic device including hardware, software, or embedded logic components or a combination of two or more such components and capable of carrying out the appropriate functionalities implemented or supported by client system 430. As an example and not by way of limitation, a client system 430 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 430. A client system 430 may enable a network user at client system 430 to access network 410. A client system 430 may enable its user to communicate with other users at other client systems 430.

In particular embodiments, client system 430 may include a web browser 432, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 430 may enter a Uniform Resource Locator (URL) or other address directing the web browser 432 to a particular server (such as server 462, or a server associated with a third-party system 470), and the web browser 432 may generate a Hyper Text Transfer Protocol (HTTP) request and communicate the HTTP request to server. The server may accept the HTTP request and communicate to client system 430 one or more Hyper Text Markup Language (HTML) files responsive to the HTTP request. Client system 430 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 460 may be a network-addressable computing system that can host an online social network. Social-networking system 460 may generate, store, receive, and send social-networking data, such as, for example, user-profile data, concept-profile data, social-graph information, or other suitable data related to the online social network. Social-networking system 460 may be accessed by the other components of network environment 400 either directly or via network 410. As an example and not by way of limitation, client system 430 may access social-networking system 460 using a web browser 432, or a native application associated with social-networking system 460 (e.g., a mobile social-networking application, a messaging application, another suitable application, or any combination thereof) either directly or via network 410. In particular embodiments, social-networking system 460 may include one or more servers 462. Each server 462 may be a unitary server or a distributed server spanning multiple computers or multiple datacenters. Servers 462 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 462 may include hardware, software, or embedded logic components or a combination of two or more such components for carrying out the appropriate functionalities implemented or supported by server 462. In particular embodiments, social-networking system 460 may include one or more data stores 464. Data stores 464 may be used to store various types of information. In particular embodiments, the information stored in data stores 464 may be organized according to specific data structures. In particular embodiments, each data store 464 may be a relational, columnar, correlation, or other suitable database. Although this disclosure describes or illustrates particular types of databases, this disclosure contemplates any suitable types of databases. Particular embodiments may provide interfaces that enable a client system 430, a social-networking system 460, or a third-party system 470 to manage, retrieve, modify, add, or delete, the information stored in data store 464.

In particular embodiments, social-networking system 460 may store one or more social graphs in one or more data stores 464. In particular embodiments, a social graph may include multiple nodes—which may include multiple user nodes (each corresponding to a particular user) or multiple concept nodes (each corresponding to a particular concept)—and multiple edges connecting the nodes. Social-networking system 460 may provide users of the online social network the ability to communicate and interact with other users. In particular embodiments, users may join the online social network via social-networking system 460 and then add connections (e.g., relationships) to a number of other users of social-networking system 460 to whom they want to be connected. Herein, the term “friend” may refer to any other user of social-networking system 460 with whom a user has formed a connection, association, or relationship via social-networking system 460.

In particular embodiments, social-networking system 460 may provide users with the ability to take actions on various types of items or objects, supported by social-networking system 460. As an example and not by way of limitation, the items and objects may include groups or social networks to which users of social-networking system 460 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 460 or by an external system of third-party system 470, which is separate from social-networking system 460 and coupled to social-networking system 460 via a network 410.

In particular embodiments, social-networking system 460 may be capable of linking a variety of entities. As an example and not by way of limitation, social-networking system 460 may enable users to interact with each other as well as receive content from third-party systems 470 or other entities, or to allow users to interact with these entities through an application programming interfaces (API) or other communication channels.

In particular embodiments, a third-party system 470 may include one or more types of servers, one or more data stores, one or more interfaces, including but not limited to APIs, one or more web services, one or more content sources, one or more networks, or any other suitable components, e.g., that servers may communicate with. A third-party system 470 may be operated by a different entity from an entity operating social-networking system 460. In particular embodiments, however, social-networking system 460 and third-party systems 470 may operate in conjunction with each other to provide social-networking services to users of social-networking system 460 or third-party systems 470. In this sense, social-networking system 460 may provide a platform, or backbone, which other systems, such as third-party systems 470, may use to provide social-networking services and functionality to users across the Internet.

In particular embodiments, a third-party system 470 may include a third-party content object provider. A third-party content object provider may include one or more sources of content objects, which may be communicated to a client system 430. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 460 also includes user-generated content objects, which may enhance a user's interactions with social-networking system 460. User-generated content may include anything a user can add, upload, send, or “post” to social-networking system 460. As an example and not by way of limitation, a user communicates posts to social-networking system 460 from a client system 430. Posts may include data such as status updates or other textual data, location information, photos, videos, links, music or other similar data or media. Content may also be added to social-networking system 460 by a third-party through a “communication channel,” such as a newsfeed or stream.

In particular embodiments, social-networking system 460 may include a variety of servers, sub-systems, programs, modules, logs, and data stores. In particular embodiments, social-networking system 460 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 460 may also include suitable components such as network interfaces, security mechanisms, load balancers, failover servers, management-and-network-operations consoles, other suitable components, or any suitable combination thereof. In particular embodiments, social-networking system 460 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 460 to one or more client systems 430 or one or more third-party system 470 via network 410. The web server may include a mail server or other messaging functionality for receiving and routing messages between social-networking system 460 and one or more client systems 430. An API-request server may allow a third-party system 470 to access information from social-networking system 460 by calling one or more APIs. An action logger may be used to receive communications from a web server about a user's actions on or off social-networking system 460. In conjunction with the action log, a third-party-content-object log may be maintained of user exposures to third-party-content objects. A notification controller may provide information regarding content objects to a client system 430. Information may be pushed to a client system 430 as notifications, or information may be pulled from client system 430 responsive to a request received from client system 430. Authorization servers may be used to enforce one or more privacy settings of the users of social-networking system 460. A privacy setting of a user determines how particular information associated with a user can be shared. The authorization server may allow users to opt in to or opt out of having their actions logged by social-networking system 460 or shared with other systems (e.g., third-party system 470), such as, for example, by setting appropriate privacy settings. Third-party-content-object stores may be used to store content objects received from third parties, such as a third-party system 470. Location stores may be used for storing location information received from client systems 430 associated with users. Advertisement-pricing modules may combine social information, the current time, location information, or other suitable information to provide relevant advertisements, in the form of notifications, to a user.

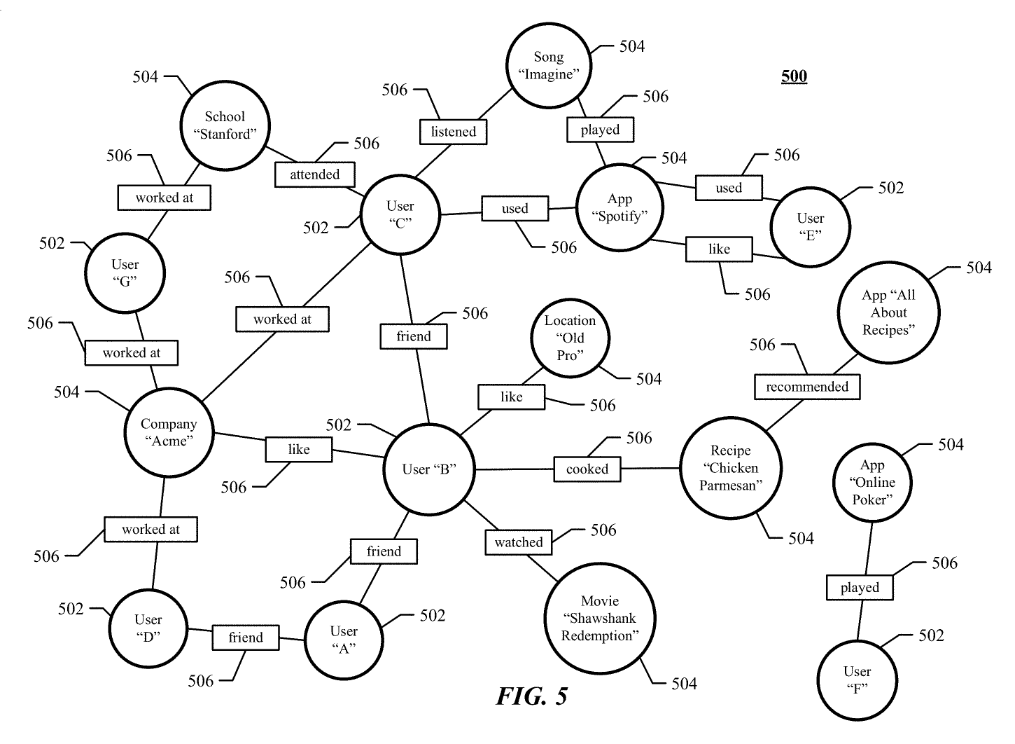

FIG. 5 illustrates example social graph 500. In particular embodiments, social-networking system 460 may store one or more social graphs 500 in one or more data stores. In particular embodiments, social graph 500 may include multiple nodes—which may include multiple user nodes 502 or multiple concept nodes 504—and multiple edges 506 connecting the nodes. Example social graph 500 illustrated in FIG. 5 is shown, for didactic purposes, in a two-dimensional visual map representation. In particular embodiments, a social-networking system 460, client system 430, or third-party system 470 may access social graph 500 and related social-graph information for suitable applications. The nodes and edges of social graph 500 may be stored as data objects, for example, in a data store (such as a social-graph database). Such a data store may include one or more searchable or queryable indexes of nodes or edges of social graph 500.

In particular embodiments, a user node 502 may correspond to a user of social-networking system 460. As an example and not by way of limitation, a user may be an individual (human user), an entity (e.g., an enterprise, business, or third-party application), or a group (e.g., of individuals or entities) that interacts or communicates with or over social-networking system 460. In particular embodiments, when a user registers for an account with social-networking system 460, social-networking system 460 may create a user node 502 corresponding to the user, and store the user node 502 in one or more data stores. Users and user nodes 502 described herein may, where appropriate, refer to registered users and user nodes 502 associated with registered users. In addition or as an alternative, users and user nodes 502 described herein may, where appropriate, refer to users that have not registered with social-networking system 460. In particular embodiments, a user node 502 may be associated with information provided by a user or information gathered by various systems, including social-networking system 460. As an example and not by way of limitation, a user may provide his or her name, profile picture, contact information, birth date, sex, marital status, family status, employment, education background, preferences, interests, or other demographic information. In particular embodiments, a user node 502 may be associated with one or more data objects corresponding to information associated with a user. In particular embodiments, a user node 502 may correspond to one or more webpages.

In particular embodiments, a concept node 504 may correspond to a concept. As an example and not by way of limitation, a concept may correspond to a place (such as, for example, a movie theater, restaurant, landmark, or city); a website (such as, for example, a website associated with social-network system 460 or a third-party website associated with a web-application server); an entity (such as, for example, a person, business, group, sports team, or celebrity); a resource (such as, for example, an audio file, video file, digital photo, text file, structured document, or application) which may be located within social-networking system 460 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 504 may be associated with information of a concept provided by a user or information gathered by various systems, including social-networking system 460. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 504 may be associated with one or more data objects corresponding to information associated with concept node 504. In particular embodiments, a concept node 504 may correspond to one or more webpages.

In particular embodiments, a node in social graph 500 may represent or be represented by a webpage (which may be referred to as a “profile page”). Profile pages may be hosted by or accessible to social-networking system 460. Profile pages may also be hosted on third-party websites associated with a third-party server 470. As an example and not by way of limitation, a profile page corresponding to a particular external webpage may be the particular external webpage and the profile page may correspond to a particular concept node 504. Profile pages may be viewable by all or a selected subset of other users. As an example and not by way of limitation, a user node 502 may have a corresponding user-profile page in which the corresponding user may add content, make declarations, or otherwise express himself or herself. As another example and not by way of limitation, a concept node 504 may have a corresponding concept-profile page in which one or more users may add content, make declarations, or express themselves, particularly in relation to the concept corresponding to concept node 504.

In particular embodiments, a concept node 504 may represent a third-party webpage or resource hosted by a third-party system 470. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 430 to send to social-networking system 460 a message indicating the user's action. In response to the message, social-networking system 460 may create an edge (e.g., a check-in-type edge) between a user node 502 corresponding to the user and a concept node 504 corresponding to the third-party webpage or resource and store edge 506 in one or more data stores.

In particular embodiments, a pair of nodes in social graph 500 may be connected to each other by one or more edges 506. An edge 506 connecting a pair of nodes may represent a relationship between the pair of nodes. In particular embodiments, an edge 506 may include or represent one or more data objects or attributes corresponding to the relationship between a pair of nodes. As an example and not by way of limitation, a first user may indicate that a second user is a “friend” of the first user. In response to this indication, social-networking system 460 may send a “friend request” to the second user. If the second user confirms the “friend request,” social-networking system 460 may create an edge 506 connecting the first user's user node 502 to the second user's user node 502 in social graph 500 and store edge 506 as social-graph information in one or more of data stores 464. In the example of FIG. 5, social graph 500 includes an edge 506 indicating a friend relation between user nodes 502 of user “A” and user “B” and an edge indicating a friend relation between user nodes 502 of user “C” and user “B.” Although this disclosure describes or illustrates particular edges 506 with particular attributes connecting particular user nodes 502, this disclosure contemplates any suitable edges 506 with any suitable attributes connecting user nodes 502. As an example and not by way of limitation, an edge 506 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 500 by one or more edges 506.

In particular embodiments, an edge 506 between a user node 502 and a concept node 504 may represent a particular action or activity performed by a user associated with user node 502 toward a concept associated with a concept node 504. As an example and not by way of limitation, as illustrated in FIG. 5, a user may “like,” “attended,” “played,” “listened,” “cooked,” “worked at,” or “watched” a concept, each of which may correspond to a edge type or subtype. A concept-profile page corresponding to a concept node 504 may include, for example, a selectable “check in” icon (such as, for example, a clickable “check in” icon) or a selectable “add to favorites” icon. Similarly, after a user clicks these icons, social-networking system 460 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 460 may create a “listened” edge 506 and a “used” edge (as illustrated in FIG. 5) between user nodes 502 corresponding to the user and concept nodes 504 corresponding to the song and application to indicate that the user listened to the song and used the application. Moreover, social-networking system 460 may create a “played” edge 506 (as illustrated in FIG. 5) between concept nodes 504 corresponding to the song and the application to indicate that the particular song was played by the particular application. In this case, “played” edge 506 corresponds to an action performed by an external application (SPOTIFY) on an external audio file (the song “Imagine”). Although this disclosure describes particular edges 506 with particular attributes connecting user nodes 502 and concept nodes 504, this disclosure contemplates any suitable edges 506 with any suitable attributes connecting user nodes 502 and concept nodes 504. Moreover, although this disclosure describes edges between a user node 502 and a concept node 504 representing a single relationship, this disclosure contemplates edges between a user node 502 and a concept node 504 representing one or more relationships. As an example and not by way of limitation, an edge 506 may represent both that a user likes and has used at a particular concept. Alternatively, another edge 506 may represent each type of relationship (or multiples of a single relationship) between a user node 502 and a concept node 504 (as illustrated in FIG. 5 between user node 502 for user “E” and concept node 504 for “SPOTIFY”).

In particular embodiments, social-networking system 460 may create an edge 506 between a user node 502 and a concept node 504 in social graph 500. As an example and not by way of limitation, a user viewing a concept-profile page (such as, for example, by using a web browser or a special-purpose application hosted by the user's client system 430) may indicate that he or she likes the concept represented by the concept node 504 by clicking or selecting a “Like” icon, which may cause the user's client system 430 to send to social-networking system 460 a message indicating the user's liking of the concept associated with the concept-profile page. In response to the message, social-networking system 460 may create an edge 506 between user node 502 associated with the user and concept node 504, as illustrated by “like” edge 506 between the user and concept node 504. In particular embodiments, social-networking system 460 may store an edge 506 in one or more data stores. In particular embodiments, an edge 506 may be automatically formed by social-networking system 460 in response to a particular user action. As an example and not by way of limitation, if a first user uploads a picture, watches a movie, or listens to a song, an edge 506 may be formed between user node 502 corresponding to the first user and concept nodes 504 corresponding to those concepts. Although this disclosure describes forming particular edges 506 in particular manners, this disclosure contemplates forming any suitable edges 506 in any suitable manner.

In particular embodiments, an advertisement may be text (which may be HTML-linked), one or more images (which may be HTML-linked), one or more videos, audio, other suitable digital object files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social-networking system 460). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social-networking system 460 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social-networking system 460) or RSVP (e.g., through social-networking system 460) to an event associated with the advertisement. In addition or as an alternative, an advertisement may include social-networking-system content directed to the user. As an example and not by way of limitation, an advertisement may display information about a friend of the user within social-networking system 460 who has taken an action associated with the subject matter of the advertisement.

In particular embodiments, an advertisement may be text (which may be HTML-linked), one or more images (which may be HTML-linked), one or more videos, audio, other suitable digital object files, a suitable combination of these, or any other suitable advertisement in any suitable digital format presented on one or more web pages, in one or more e-mails, or in connection with search results requested by a user. In addition or as an alternative, an advertisement may be one or more sponsored stories (e.g., a news-feed or ticker item on social-networking system 460). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. The social action may be promoted within or on social-networking system 460. In addition or as an alternative, the social action may be promoted outside or off of social-networking system 460, where appropriate. In particular embodiments, a page may be an on-line presence (such as a webpage or website within or outside of social-networking system 460) of a business, organization, or brand facilitating its sharing of stories and connecting with people. A page may be customized, for example, by adding applications, posting stories, or hosting events.

A sponsored story may be generated from stories in users' news feeds and promoted to specific areas within displays of users' web browsers when viewing a web page associated with social-networking system 460. Sponsored stories are more likely to be viewed by users, at least in part because sponsored stories generally involve interactions or suggestions by the users' friends, fan pages, or other connections. In connection with sponsored stories, particular embodiments may utilize one or more systems, components, elements, functions, methods, operations, or steps disclosed in U.S. patent application Ser. No. 13/327,557, entitled “Sponsored Stories Unit Creation from Organic Activity Stream” and filed 15 Dec. 2011, U.S. Patent Application Publication No. 2012/0203831, entitled “Sponsored Stories Unit Creation from Organic Activity Stream” and filed 3 Feb. 2012 as U.S. patent application Ser. No. 13/020,745, or U.S. Patent Application Publication No. 2012/0233009, entitled “Endorsement Subscriptions for Sponsored Stories” and filed 9 Mar. 2011 as U.S. patent application Ser. No. 13/044,506, which are all incorporated herein by reference as an example and not by way of limitation. In particular embodiments, sponsored stories may utilize computer-vision algorithms to detect products in uploaded images or photos lacking an explicit connection to an advertiser as disclosed in U.S. patent application Ser. No. 13/212,356, entitled “Computer-Vision Content Detection for Sponsored Stories” and filed 18 Aug. 2011, which is incorporated herein by reference as an example and not by way of limitation.

As described above, an advertisement may be text (which may be HTML-linked), one or more images (which may be HTML-linked), one or more videos, audio, one or more ADOBE FLASH files, a suitable combination of these, or any other suitable advertisement in any suitable digital format. In particular embodiments, an advertisement may be requested for display within third-party webpages, social-networking-system webpages, or other pages. An advertisement may be displayed in a dedicated portion of a page, such as in a banner area at the top of the page, in a column at the side of the page, in a GUI of the page, in a pop-up window, over the top of content of the page, or elsewhere with respect to the page. In addition or as an alternative, an advertisement may be displayed within an application or within a game. An advertisement may be displayed within dedicated pages, requiring the user to interact with or watch the advertisement before the user may access a page, utilize an application, or play a game. The user may, for example view the advertisement through a web browser.

A user may interact with an advertisement in any suitable manner. The user may click or otherwise select the advertisement, and the advertisement may direct the user (or a browser or other application being used by the user) to a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). In particular embodiments, an advertisement may include one or more games, which a user or other application may play in connection with the advertisement. An advertisement may include functionality for responding to a poll or question in the advertisement.

An advertisement may include social-networking-system functionality that a user may interact with. For example, an advertisement may enable a user to “like” or otherwise endorse the advertisement by selecting an icon or link associated with endorsement. Similarly, a user may share the advertisement with another user (e.g., through social-networking system 460) or RSVP (e.g., through social-networking system 460) to an event associated with the advertisement. In addition or as an alternative, an advertisement may include social-networking-system content directed to the user. For example, an advertisement may display information about a friend of the user within social-networking system 460 who has taken an action associated with the subject matter of the advertisement.

Social-networking-system functionality or content may be associated with an advertisement in any suitable manner. For example, an advertising system (which may include hardware, software, or both for receiving bids for advertisements and selecting advertisements in response) may retrieve social-networking functionality or content from social-networking system 460 and incorporate the retrieved social-networking functionality or content into the advertisement before serving the advertisement to a user. Examples of selecting and providing social-networking-system functionality or content with an advertisement are disclosed in U.S. Patent Application Publication No. 2012/0084160, entitled “Providing Social Endorsements with Online Advertising” and filed 5 Oct. 2010 as U.S. patent application Ser. No. 12/898,662, and in U.S. Patent Application Publication No. 2012/0232998, entitled “Selecting Social Endorsement Information for an Advertisement for Display to a Viewing User” and filed 8 Mar. 2011 as U.S. patent application Ser. No. 13/043,424, which are both incorporated herein by reference as examples only and not by way of limitation. Interacting with an advertisement that is associated with social-networking-system functionality or content may cause information about the interaction to be displayed in a profile page of the user in social-networking-system 460.

Particular embodiments may facilitate the delivery of advertisements to users that are more likely to find the advertisements more relevant or useful. For example, an advertiser may realize higher conversion rates (and therefore higher return on investment (ROI) from advertising) by identifying and targeting users that are more likely to find its advertisements more relevant or useful. The advertiser may use user-profile information in social-networking system 460 to identify those users. In addition or as an alternative, social-networking system 460 may use user-profile information in social-networking system 460 to identify those users for the advertiser. As examples and not by way of limitation, particular embodiments may target users with the following: invitations or suggestions of events; suggestions regarding coupons, deals, or wish-list items; suggestions regarding friends' life events; suggestions regarding groups; advertisements; or social advertisements. Such targeting may occur, where appropriate, on or within social-networking system 460, off or outside of social-networking system 460, or on mobile computing devices of users. When on or within social-networking system 460, such targeting may be directed to users' news feeds, search results, e-mail or other in-boxes, or notifications channels or may appear in particular area of web pages of social-networking system 460, such as a right-hand side of a web page in a concierge or grouper area (which may group along a right-hand rail advertisements associated with the same concept, node, or object) or a network-ego area (which may be based on what a user is viewing on the web page and a current news feed of the user). When off or outside of social-networking system 460, such targeting may be provided through a third-party website, e.g., involving an ad exchange or a social plug-in. When on a mobile computing device of a user, such targeting may be provided through push notifications to the mobile computing device.

Targeting criteria used to identify and target users may include explicit, stated user interests on social-networking system 460 or explicit connections of a user to a node, object, entity, brand, or page on social-networking system 460. In addition or as an alternative, such targeting criteria may include implicit or inferred user interests or connections (which may include analyzing a user's history, demographic, social or other activities, friends' social or other activities, subscriptions, or any of the preceding of other users similar to the user (based, e.g., on shared interests, connections, or events)). Particular embodiments may utilize platform targeting, which may involve platform and “like” impression data; contextual signals (e.g., “Who is viewing now or has viewed recently the page for COCA-COLA?”); light-weight connections (e.g., “check-ins”); connection lookalikes; fans; extracted keywords; EMU advertising; inferential advertising; coefficients, affinities, or other social-graph information; friends-of-friends connections; pinning or boosting; deals; polls; household income, social clusters or groups; products detected in images or other media; social- or open-graph edge types; geo-prediction; views of profile or pages; status updates or other user posts (analysis of which may involve natural-language processing or keyword extraction); events information; or collaborative filtering. Identifying and targeting users may also include privacy settings (such as user opt-outs), data hashing, or data anonymization, as appropriate.

To target users with advertisements, particular embodiments may utilize one or more systems, components, elements, functions, methods, operations, or steps disclosed in the following, which are all incorporated herein by reference as examples and not by way of limitation: U.S. Patent Application Publication No. 2009/0119167, entitled “Social Advertisements and Other Informational Messages on a Social Networking Website and Advertising Model for Same” and filed 18 Aug. 2008 as U.S. patent application Ser. No. 12/193,702; U.S. Patent Application Publication No. 2009/0070219, entitled “Targeting Advertisements in a Social Network” and filed 20 Aug. 2008 as U.S. patent application Ser. No. 12/195,321; U.S. Patent Application Publication No. 2012/0158501, entitled “Targeting Social Advertising to Friends of Users Who Have Interacted With an Object Associated with the Advertising” and filed 15 Dec. 2010 as U.S. patent application Ser. No. 12/968,786; or U.S. Patent Application Publication No. 2012/0166532, entitled “Contextually Relevant Affinity Prediction in a Social-Networking System” and filed 23 Dec. 2010 as U.S. patent application Ser. No. 12/978,265.

An advertisement may be presented or otherwise delivered using plug-ins for web browsers or other applications, iframe elements, news feeds, tickers, notifications (which may include, for example, e-mail, Short Message Service (SMS) messages, or notifications), or other means. An advertisement may be presented or otherwise delivered to a user on a mobile or other computing device of the user. In connection with delivering advertisements, particular embodiments may utilize one or more systems, components, elements, functions, methods, operations, or steps disclosed in the following, which are all incorporated herein by reference as examples and not by way of limitation: U.S. Patent Application Publication No. 2012/0159635, entitled “Comment Plug-In for Third-Party System” and filed 15 Dec. 2010 as U.S. patent application Ser. No. 12/969,368; U.S. Patent Application Publication No. 2012/0158753, entitled “Comment Ordering System” and filed 15 Dec. 2010 as U.S. patent application Ser. No. 12/969,408; U.S. Pat. No. 7,669,123, entitled “Dynamically Providing a News Feed About a User of a Social Network” and filed 11 Aug. 2006 as U.S. patent application Ser. No. 11/503,242; U.S. Pat. No. 8,402,094, entitled “Providing a Newsfeed Based on User Affinity for Entities and Monitored Actions in a Social Network Environment” and filed 11 Aug. 2006 as U.S. patent application Ser. No. 11/503,093; U.S. Patent Application Publication No. 2012/0072428, entitled “Action Clustering for News Feeds” and filed 16 Sep. 2010 as U.S. patent application Ser. No. 12/884,010; U.S. Patent Application Publication No. 2011/0004692, entitled “Gathering Information about Connections in a Social Networking Service” and filed 1 Jul. 2009 as U.S. patent application Ser. No. 12/496,606; U.S. Patent Application Publication No. 2008/0065701, entitled “Method and System for Tracking Changes to User Content in an Online Social Network” and filed 12 Sep. 2006 as U.S. patent application Ser. No. 11/531,154; U.S. Patent Application Publication No. 2008/0065604, entitled “Feeding Updates to Landing Pages of Users of an Online Social Network from External Sources” and filed 17 Jan. 2007 as U.S. patent application Ser. No. 11/624,088; U.S. Pat. No. 8,244,848, entitled “Integrated Social-Network Environment” and filed 19 Apr. 2010 as U.S. patent application Ser. No. 12/763,171; U.S. Patent Application Publication No. 2011/0083101, entitled “Sharing of Location-Based Content Item in Social-Networking Service” and filed 6 Oct. 2009 as U.S. patent application Ser. No. 12/574,614; U.S. Pat. No. 8,150,844, entitled “Location Ranking Using Social-Graph Information” and filed 18 Aug. 2010 as U.S. patent application Ser. No. 12/858,718; U.S. patent application Ser. No. 13/051,286, entitled “Sending Notifications to Users Based on Users' Notification Tolerance Levels” and filed 18 Mar. 2011; U.S. patent application Ser. No. 13/096,184, entitled “Managing Notifications Pushed to User Devices” and filed 28 Apr. 2011; U.S. patent application Ser. No. 13/276,248, entitled “Platform-Specific Notification Delivery Channel” and filed 18 Oct. 2011; or U.S. Patent Application Publication No. 2012/0197709, entitled “Mobile Advertisement with Social Component for Geo-Social Networking System” and filed 1 Feb. 2011 as U.S. patent application Ser. No. 13/019,061. Although this disclosure describes or illustrates particular advertisements being delivered in particular ways and in connection with particular content, this disclosure contemplates any suitable advertisements delivered in any suitable ways and in connection with any suitable content.

In particular embodiments, social-networking system 460 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 470 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 460 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part a the history of the user's actions. Coefficients may be used to predict any number of actions, which may be within or outside of the online social network. As an example and not by way of limitation, these actions may include various types of communications, such as sending messages, posting content, or commenting on content; various types of a observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 460 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 460 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 460 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 460 may calculate a coefficient based on a user's actions. Social-networking system 460 may monitor such actions on the online social network, on a third-party system 470, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 460 may calculate a coefficient based on the user's actions with particular types of content. The content may be associated with the online social network, a third-party system 470, or another suitable system. The content may include users, profile pages, posts, news stories, headlines, instant messages, chat room conversations, emails, advertisements, pictures, video, music, other suitable objects, or any combination thereof. Social-networking system 460 may analyze a user's actions to determine whether one or more of the actions indicate an affinity for subject matter, content, other users, and so forth. As an example and not by way of limitation, if a user may make frequently posts content related to “coffee” or variants thereof, social-networking system 460 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 460 may calculate a coefficient based on the type of relationship between particular objects. Referencing the social graph 500, social-networking system 460 may analyze the number and/or type of edges 506 connecting particular user nodes 502 and concept nodes 504 when calculating a coefficient. As an example and not by way of limitation, user nodes 502 that are connected by a spouse-type edge (representing that the two users are married) may be assigned a higher coefficient than a user nodes 502 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, social-networking system 460 may determine that the user has a higher coefficient with respect to the first photo than the second photo because having a tagged-in-type relationship with content may be assigned a higher weight and/or rating than having a like-type relationship with content. In particular embodiments, social-networking system 460 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 460 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 500. As an example and not by way of limitation, social-graph entities that are closer in the social graph 500 (i.e., fewer degrees of separation) may have a higher coefficient than entities that are further apart in the social graph 500.

In particular embodiments, social-networking system 460 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 430 of the user). A first user may be more interested in other users or concepts that are closer to the first user. As an example and not by way of limitation, if a user is one mile from an airport and two miles from a gas station, social-networking system 460 may determine that the user has a higher coefficient for the airport than the gas station based on the proximity of the airport to the user.

In particular embodiments, social-networking system 460 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 460 may provide information that is relevant to user's interests and current circumstances, increasing the likelihood that they will find such information of interest. In particular embodiments, social-networking system 460 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 460 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 460 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 470 (e.g., via an API or other communication channel), or from another suitable system. In response to the request, social-networking system 460 may calculate the coefficient (or access the coefficient information if it has previously been calculated and stored). In particular embodiments, social-networking system 460 may measure an affinity with respect to a particular process. Different processes (both internal and external to the online social network) may request a coefficient for a particular object or set of objects. Social-networking system 460 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 204 corresponding to a particular photo may have a privacy setting specifying that the photo may only be accessed by users tagged in the photo and their friends. In particular embodiments, privacy settings may allow users to opt in or opt out of having their actions logged by social-networking system 460 or shared with other systems (e.g., third-party system 470). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 470, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 462 may be authorization/privacy servers for enforcing privacy settings. In response to a request from a user (or other entity) for a particular object stored in a data store 464, social-networking system 460 may send a request to the data store 464 for the object. The request may identify the user associated with the request and may only be sent to the user (or a client system 430 of the user) if the authorization server determines that the user is authorized to access the object based on the privacy settings associated with the object. If the requesting user is not authorized to access the object, the authorization server may prevent the requested object from being retrieved from the data store 464, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

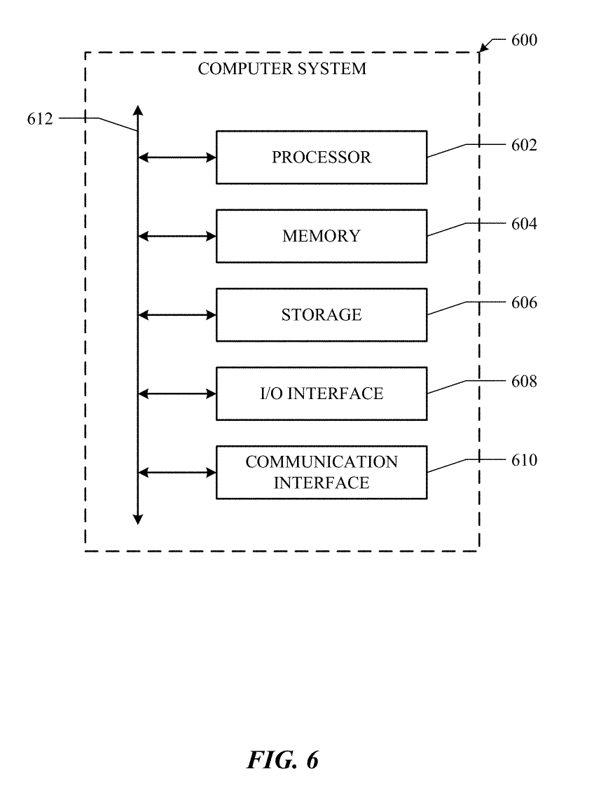

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
by a computer server machine, receiving, from a first user, instructions to edit an original photo, wherein the original photo was posted by a second user;
by the computer server machine, creating an edited photo based on the original photo in accordance with the instructions;
by the computer server machine, storing the edited photo in association with the first user; and
by the computer server machine, distributing the edited photo in association with the original photo.

2. The method of claim 1, wherein the instructions to edit the original photo comprises adding stickers or text to the original photo.

3. The method of claim 1, wherein the instructions to edit the original photo comprises at least one of the following: crop; adjust the contrast, saturation, shadows, or highlights; convert to black and white; and add one or more pre-determined filters.

4. The method of claim 1, wherein distributing the edited photo comprises posting the edited photo in a comment region associated with the original photo.

5. The method of claim 1, wherein distributing the edited photo comprises resharing the edited photo, wherein resharing the edited photo comprises posting the edited photo in a region independent of the original photo on an online social network.

6. The method of claim 5, wherein the edited photo is posted in the region independent of the original photo only if the first user has permission to reshare the edited photo.

7. The method of claim 1, further comprising, by the computer server machine, executing the instructions to edit the original photo only if the first user has permission to edit the original photo.

8. The method of claim 1, wherein editing the original photo occurs only if the first user has editing access to the original photo, the editing access being based on a relationship between the first user and the second user.

9. The method of claim 1, wherein creating an edited photo comprises:
creating a stencil overlay based on the instructions to edit the original photo; and
creating a pointer to the original photo, wherein the edited photo comprises the stencil overlay being superimposed on the original photo.

10. The method of claim 1, wherein creating the edited photo comprises:
duplicating the original photo to create a duplicated photo; and
applying the editing instructions to the duplicated photo.

11. The method of claim 10, further comprising deleting the duplicated photo if the original photo is deleted.

12. The method of claim 1, further comprising restricting the editing instructions to one or more types of instructions approved by the second user.

13. The method of claim 5, wherein permission to reshare is based on a relationship between a user who desires to reshare the edited photo and the second user.

14. The method of claim 5, wherein permission to reshare is based on a group in which the user who desires to reshare the edited photo belongs.

15. The method of claim 1, further comprising storing, in a computer memory storage device, the instructions to edit the original photo to create a template for editing future photos.

16. The method of claim 9, further comprising storing the stencil in a computer memory storage device if the photo is deleted.

17. One or more computer-readable non-transitory storage media embodying software configured when executed to:
receive instructions to edit an original photo from a first user, wherein the original photo was posted by a second user;
create an edited photo based on the original photo in accordance with the instructions;
store the edited photo in association with the first user; and
distribute the edited photo in association with the original photo.

18. The one or more computer-readable non-transitory storage media of claim 17, embodying software further configured to reshare the edited photo, wherein resharing the edited photo comprises posting the edited photo in a region independent of the original photo on an online social network.

19. The one or more computer-readable non-transitory storage media of claim 17, wherein creating an edited photo comprises:
creating a stencil overlay based on the instructions to edit the original photo; and
creating a pointer to the original photo, wherein the edited photo comprises the stencil overlay being superimposed on the original photo

20. A device comprising:
one or more processors; and
one or more computer-readable non-transitory storage media coupled to the processors and embodying software configured when executed to:
receive instructions to edit an original photo from a first user, wherein the original photo was posted by a second user;
create an edited photo based on the original photo in accordance with the instructions;
store the edited photo in association with the first user; and
distribute the edited photo in association with the original photo.
